(19) United States
(12) Patent Application Publication
(10) Pub. No.: US 2003/0229716 A1
(43) Pub. Date: Dec. 11, 2003

(54) System and method for transferring financial information

(76) Inventor: David Holland, Austin, TX (US)

Correspondence Address: Raffi Gostanian, Jr., Jackson Walker L.L.P., Suite 600, 2435 North Central Expressway, Richardson, TX, 75080, US

(21) Appl. No.: 10/165,656

(22) Filed: Jun. 8, 2002

(51) Int. Cl. G06F 17/60

(52) U.S. Cl. 709/246; 705/1

(57) ABSTRACT

The present invention provides a system and method for transferring financial information which includes wirelessly sending, by a client, a first request for information, receiving, by a first server, the wirelessly sent first request, converting, by the first server, the wirelessly sent first request into a second request for the information, sending, by the first server, the second request, and receiving, by a second server, the second request. The method continues with sending, by the second server, the requested information, receiving, by the first server, the requested information, converting, by the first server, the requested information into a first format, and sending, by the first server, the first format to the client.

### RELATED APPLICATIONS

The present invention claims priority from provisional patent application serial No. 60/296,544, filed on Jun., 7 2001, assigned to the assignee of the present invention, and titled “Algorithm For Wireless Transmitting Financial Information.”

### FIELD OF THE INVENTION

The present invention relates to the transfer of information and, more particularly, to a system and method for transferring financial information.

### BACKGROUND OF THE INVENTION

Wireless communication devices, such as mobile phones, two-way messaging pagers, and personal digital assistants, are used to access a multitude of information via various data networks such as the Internet. The ability to deliver interactive and transaction-oriented applications and services to such wireless devices is an important consideration. Current mobile devices, equipped with wireless data applications, can receive stock quotes, news, messaging and other information. Some of the services touted by wireless carriers and mobile device manufacturers include real-time stock trading, wireless banking, mobile commerce and interactive games. Such services are provided by existing network infrastructure such as switches, base stations, and base station controllers.

A limitation of the current network infrastructure is the inability to securely deliver real-time content to the wireless devices because data being accessed by the wireless devices are typically transferred from back-end servers, through a gateway, and then on to a wireless device for use by a subscriber. Essentially, most wireless data currently uses the Internet to deliver content to the wireless devices via a protocol known as Wireless Application Protocol (WAP). The WAP standard offers the ability to deliver services to wireless devices and is based on Internet standards such as HTML, XML and TCP/IP.

The current wireless Internet infrastructure consists of networks utilizing WAP and web browser-based technologies like HTML and WML to deliver content to our mobile devices. Utilizing WAP, however, usually requires data to pass through a gateway thus weakening security. Such a limitation is unacceptable for banking and mobile commerce applications. Further, since WAP is a wireless application protocol, it is not intended to be a true application environment able to run rich, colorful, graphic applications. Currently, the applications for wireless devices are usually monochromatic and simple in functionality.

Further limitations of the conventional art include the inability to reduce network traffic and latency issues associated with the transfer of wireless data. Such limitations may cause serious delays in receiving important financial information thus decreasing the value of the received information.

Therefore, it is desirable for the present invention to overcome the conventional limitations associated with transferring financial information between a wireless device and a server such as a web server.

### SUMMARY OF THE INVENTION

The present invention achieves technical advantages as a system and method for transferring financial information. In one embodiment, a method for transferring information comprises wirelessly sending, by a client, a first request for information, receiving, by a first server, the wirelessly sent first request, converting, by the first server, the wirelessly sent first request into a second request for the information, sending, by the first server, the second request, and receiving, by a second server, the second request. The method continues with sending, by the second server, the requested information, receiving, by the first server, the requested information, converting, by the first server, the requested information into a first format, and sending, by the first server, the first format to the client.

In another embodiment, a method for transferring information comprises initiating a program on a client, requesting data via the program, receiving, by a first module, the request, wherein the request includes instructions to access the data, requesting the data based on the instructions, and receiving the data, from a second module. The method continues with translating the received data, by the first module, into a format adapted to be read and used by the client, compressing the translated data, converting the compressed data into a wirelessly transmittable format, and wirelessly transmitting, by the first module, the converted data to the client.

In a further embodiment, a method for transferring financial information comprises executing an application, requesting remote data via the application, sending the request by directing a data packet to an address of a server, wherein the data packet contains instructions to query a feed interface from a financial source to return a quote object, and returning the quote object to the server. The method continues with converting the quote object into a data structure, returning a feed-independent object, and wirelessly and intermittently transmitting the feed-independent object.

In yet another embodiment, a system for transferring financial information comprises at least one wireless device and at least one server, wherein the wireless device requests remote data, and sends the request by directing a data packet to an address of the server, wherein the data packet contains instructions to query a feed interface from a financial source to return a quote object to the server, and wherein the server converts the quote object into a data structure, returns a feed-independent object, and wirelessly and intermittently transmits the feed-independent object to the wireless device. The wireless device further converts the feed-independent object into at least one of a following form: a chart, a graphical list, a text list, and a vertical scrolling capability, and displays the at least one form, wherein the converted form is based on display characteristics of the wireless device.

In yet another embodiment, a wireless device adapted to transfer financial information comprises hardware and software, wherein the hardware and the software are adapted to execute an application, send a request for remote data, via the application, by directing a data packet to an address of a location of the remote data, wirelessly receive a first converted version of the remote data, convert the first converted version to a second converted version based on display characteristics of the wireless device, and display the second converted version.

In yet a further embodiment, a server adapted to transfer financial information comprises hardware and software, wherein the hardware and the software are adapted to receive instructions to query a feed interface from a financial source, query the financial source, receive quote objects, convert the quote objects into data structures, return feed-independent objects, and perform at least one of a first actions and a second actions. The first actions comprise aggregating a portion of the feed-independent objects based on a type of the quote objects and on an order of the quote objects arrival, recording a number of common occurrences of the type, and wirelessly transmitting the type, the number of occurrences, and the feed-independent objects that are not aggregated. The second actions comprise monitoring a type of the feed-independent objects, recording changes of the type, and wirelessly transmitting the changes.

In yet a another embodiment, a computer readable medium comprises instructions for executing an application, sending a request for remote data, via the application, by directing a data packet to an address of a location of the remote data, wirelessly receiving a twice converted version of the remote data,converting the twice converted version to a third converted version based on display characteristics of the wireless device, and displaying the third converted version.

In yet a further embodiment, a computer readable medium comprises instructions for receiving instructions to query a source, querying the source, receiving quote objects from the source, converting the quote objects into a first version, converting the first version into a second version, returning source-independent objects, storing the source-independent objects, and wirelessly transmitting, via a network to a destination, the stored source-independent objects based on a size of the source-independent objects and on a minimum availability of a wireless spectrum of the network.

In yet a another embodiment, a computer readable medium comprises instructions for receiving instructions to query a source, querying the source, receiving quote objects from the source, converting the quote objects into a first version, converting the first version into a second version, returning source-independent objects based on the second version, determining a destination of the second version, converting the source-independent objects into a third version based on the destination, and wirelessly transmitting the third version based on a size of the source-independent objects and on a minimum availability of wireless spectrum.

### BRIEF DESCRIPTION OF THE DRAWINGS

FIG. 1 illustrates a diagram of a system depicting a prior art connection and a connection in accordance with the present invention;

FIG. 2 illustrates a diagram of a system in accordance with the present invention;

FIG. 3 illustrates a diagram of a wireless device camera in accordance with the present invention; and

FIG. 4 illustrates a plurality of diagrams depicting information that may be displayed on a display of the wireless device in accordance with an exemplary embodiment of the present invention.

### DETAILED DESCRIPTION OF THE INVENTION

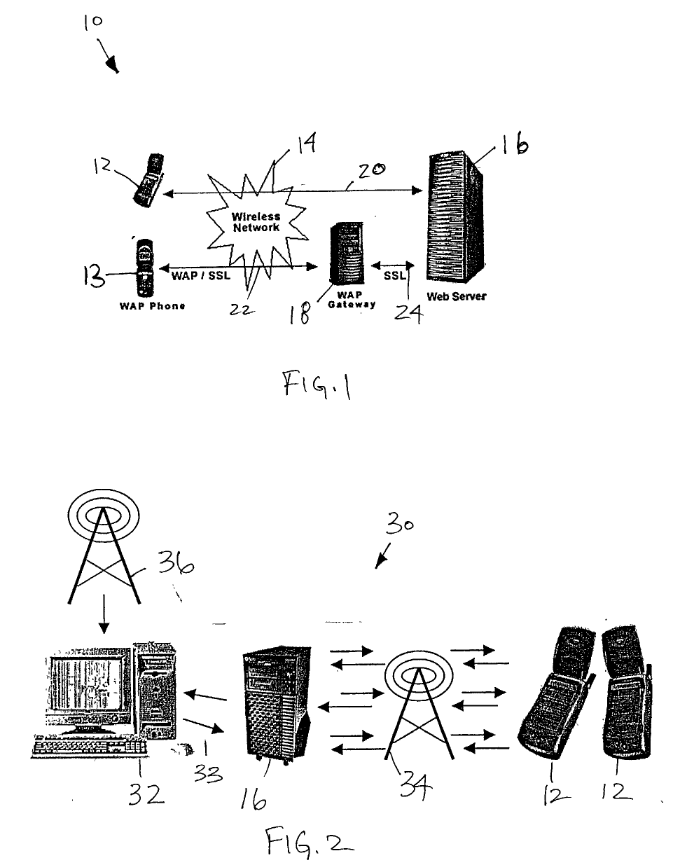

Referring now to FIG. 1, a system 10 depicting a prior art connection and a connection in accordance with the present invention is presented. The system 10 includes a wireless device 12 comprising a program (not shown) of the present invention. The program is used to request various information, such as financial information, from a web server 16, via a wireless network 14 and a connection 20. The connection 20 may be established via a mobile information device profile (MIDP). The MIDP is a set of Java application programming interfaces designed to allow mobile devices to execute applications that comply with the Java 2 Platform, Micro Edition (J2ME). J2ME technology builds on the capabilities of WAP and web-browser based technologies.

By contrast, a conventional connection 22 involves a WAP enabled phone 13 connecting to a WAP gateway 18 and further to the web server 16 via a secure sockets layer connection 24. As previously mentioned utilizing WAP requires data to pass through the gateway 18 thus weakening security.

The program of the current invention allows wireless service providers to send subscribers, for example, small Java based applications, known as MIDlets, which may appear as an icon on the wireless device 12, and can be downloaded and installed with great ease. The MIDlets enhance the user experience by creating easy-to-use and graphical interactive services.

Referring now to FIG. 2, a system 30 of the present invention is presented. The system 30 includes the wireless device(s) 12 and a server 16. The wireless device(s) 12 and the server 16 communicate via a wireless network 34. Although depicted as a cell site, the wireless network 34 comprises, for example, wireless switches, base station controllers, and a base stations. The server 16 receives financial information from a financial source 32 or financial server 32, which receives such financial information from another wireless network 36 or a wireline network (not shown).

In one embodiment of the present invention, a method for transferring information comprises wirelessly sending, by a client (such as the wireless device 12), a first request for information, receiving, by a first server (such as the server 16), the wirelessly sent first request, and converting, by the first server, the wirelessly sent first request into a second request for the information. The second request for information includes querying a feed interface 33 from a market data vendor (such as the financial server 32) to return a quote object describing, for example, financial information. The method continues with the first server sending the second request to the financial server 32 and receiving, from the financial server 32, the requested information. Upon receiving the requested information, the first server converts the requested information into a first format, and sends the first format to the client 12. The first format includes, for example, a feed independent object that is returned when the quote object is converted into, for example, a data structure adapted to be wirelessly transmitted to the client 12.

The method further comprises wirelessly receiving the first format by the client, and converting by the client the first format into a second format. Such a second format permits the financial information to be displayed on a particular client 12. As such, the client displays the second format. A description of such displayed financial information is described in reference to FIG. 4 below.

In another embodiment, a method for transferring information comprises initiating a program on the client 12, requesting data via the program, receiving, by a first module (for example, the server 16), the request, wherein the request includes instructions to access the data, requesting the data based on the instructions, and receiving the data, from a second module (for example, the financial server 32). The method continues with translating the received data, by the first module, into a format adapted to be read and used by the client, compressing the translated data, converting the compressed data into a wirelessly transmittable format, and wirelessly transmitting, by the first module, the converted data to the client.

In a further embodiment, a method for transferring financial information comprises executing an application (such as the program of the present invention), requesting remote data via the application, sending the request by directing a data packet to an address of the server 16, wherein the data packet contains instructions to query a feed interface from the financial source 32 to return a quote object, and returning the quote object to the server. The method continues with converting the quote object into a data structure, returning a feed-independent object, and wirelessly and intermittently transmitting the feed-independent object.

In yet another embodiment, the system 30 comprises at least one wireless device 12 and at least one server 16, wherein the wireless device requests remote data, and sends the request by directing a data packet (not shown) to an address (such as an internet protocol address) of the server, wherein the data packet contains instructions to query a feed interface from the financial source 32 to return a quote object to the server, and wherein the server converts the quote object into a data structure, returns a feed-independent object, and wirelessly and intermittently transmits the feed-independent object to the wireless device. The wireless device 12 further converts the feed-independent object into at least one of a following form: a chart, a graphical list, a text list, and a vertical scrolling capability, and displays the at least one form, wherein the converted form is based on display characteristics of the wireless device.

Since wireless networks, including network 30, have limited bandwidth, it is necessary to devise measures to optimize the bandwidth and handle network latency issues at the application layer. In order to do so, an encoding of the feed-independent object or application messages can greatly reduce network traffic. Encoding is possible by examining the format and semantics of messages sent from the financial source 32 to the wireless device 12. Depending on the type of message and the order of arrival, an aggregate message may be constructed at the server 16 and sent that encodes the information of a sequence of individual messages. For example duplicate financial information messages (such as duplicate bid/ask messages) may be encoded as a single aggregate message that records the total number of bid/ask messages received, but reports only once the common shared value.

The server 16 may return a plurality of feed-independent objects from a plurality of quote objects. In such a scenario, and as described above, a portion of the plurality of feed-independent objects may be aggregated based on a type of the quote objects and on an order of the quote objects arrival. A number of common occurrences of the type are recorded and the type, the number of occurrences, and the plurality of feed-independent objects that are not aggregated are wirelessly and intermittently transmitted.

Other encoding schemes imply a state model. For example, a stateful encoding of messages should not send any value that does not represent a change in value. As such, only values that have changed should be sent. For example, if a second request for a stock price is sent and the stock has increased by a certain amount, only that increased amount (and not the entire stock price) may be sent. State may be represented compactly using bytes, bitwise flags and masks. Furthermore, numeric data may be more efficiently sent in a binary format as opposed to being represented as a numeric string. As such, the server 16 monitors a type of the feed-independent objects, records changes of the type, and wirelessly and intermittently transmits the changes.

The requested remote data by the wireless device 12 comprises, for example, at least one of a following data from a group consisting of: a connect request, a full text news story, a news bulletin, a financial instrument chart, a financial instrument quote, a ping response, add area of interest, remove area of interest, and a disconnect request. The quote object comprises, for example, at least one of the types from a group consisting of: a financial instrument symbol, a latest up tick indicator, a latest down tick indicator, a traded volume, a previous days closing price, a last traded price, a change between the previous days closing price and the last traded price, a high price, a low price, an open price, a close price, a bid price, an ask price, an exchange, an electronic communication network, a time of a trade, and a size of the trade.

The wireless device 12 comprises hardware and software (such as the application of the current invention) that are adapted to execute the application, send a request for remote data, via the application, by directing a data packet to an address of a location of the remote data, wirelessly receive a first converted version (to permit wireless transmission) of the remote data, convert the first converted version to a second converted version based on display characteristics of the wireless device, and display the second converted version. The second converted version comprises at least one of a following version: a chart, a graphical list, a text list, a vertical scrolling capability, and a multimedia version comprising a live news feed, a financial instrument trading function, and related hypertext links.

Network latency problems can be addressed by caching the financial information messages at the server 16 before the information is sent to the wireless device 12. Latency is the measured time difference between a message being sent from the server 16 and received at the client 12. This requires reasonable time synchronization of both the client 12 and the server. The messages are cached (at a cache—not shown—of the server 16) and delivered at frequency intervals that may depend on wireless network latencies. Messages are delivered with embedded timestamps which provide an ability to measure total application latency (including network latency and processor latency) dynamically. A measure of dynamic latency can be configured to provide a feedback loop variable to the server 16 to adjust caching frequency intervals. In this manner caching intervals are reduced or increased in direct proportion to observed latency.

The loop feedback control variable contains a value in milliseconds for the frequency at which the cache of the server 16 is flushed to the client 12. The value is adjusted dynamically and is directly proportional to a measured message arrival latency between the client 12 and the server 16.

The loop feedback control is determined by the following equation:

loop feedback control=(k(1)X(1)+k(2)X(2) . . . K(n)X(n))/n

where i . . . N represents the latest consecutively measured N latency intervals, k(i) is the measured latency for interval i, and k(i) is the weighting coefficient for interval i. The loop feedback control variable can be used to determine an average latency.

Furthermore, caching can be configured to aggregate or disregard some messages over an interval. For example, all messages may be aggregated into a high, low, open, and close aggregate for the interval or configured so that only the last message is reported for an interval. This often makes sense when observing trade updates, for example, because a user is probably only interested in the most recent trade in an interval (earlier trades may be irrelevant). Effective caching of data is a major factor in improving application responsiveness to network and processor latencies.

The server 16 also comprises hardware and software that are adapted to receive instructions to query the feed interface 33 from the financial source 32, query the financial source, receive quote objects, convert the quote objects into data structures, return feed-independent objects and perform at least one of a first set of actions and a second set of actions. The first set of actions comprise, as previously described, aggregating a portion of the feed-independent objects based on a type of the quote objects and on an order of the quote objects arrival, recording a number of common occurrences of the type, and wirelessly transmitting the type, the number of occurrences, and the feed-independent objects that are not aggregated. The second set of actions comprise, as previously described, monitoring a type of the feed-independent objects, recording changes of the type, and wirelessly transmitting the changes.

In a further embodiment, the wireless device 12 includes a computer readable medium (or software) that comprises instructions for executing an application, sending a request for remote data, via the application, by directing a data packet to an address of a location of the remote data, wirelessly receiving a twice converted version of the remote data (for example, converted a first time by the server 16 to transfer wirelessly and again when encoded), converting the twice converted version to a third converted version based on display characteristics of the wireless device, and displaying the third converted version.

In another embodiment, the server 14 includes a computer readable medium (or software) that comprises instructions for receiving instructions to query a source, querying the source, receiving quote objects from the source, converting the quote objects into a first version, converting the first version into a second version, returning source-independent objects, storing the source-independent objects, and wirelessly transmitting (via the network 34 to a destination 12) the stored source-independent objects based on a size of the source-independent objects and on a minimum availability of a wireless spectrum of the network.

The computer readable medium of the server 14 further comprises instructions for determining a destination of the stored wirelessly transmitted source-independent objects, configuring the stored source-independent objects based on characteristics of the destination, and wirelessly transmitting the stored configured source-independent objects to the destination. Further instructions include embedding a time stamp in the stored wirelessly transmitted objects, measuring, by the time stamp, a latency of the network, wherein the latency comprises a difference between a time of transmitting the stored objects and a time of receiving the stored objects at the destination, receiving the latency, and determining an interval at which the stored objects are transmitted, wherein the interval is based on the latency.

As previously described, a plurality of latencies may be received. In such a scenario, instructions include determining an average latency based on the received plurality of latencies, and not transmitting the stored objects to the destination if the average latency is above a threshold. In such a scenario, a latest returned source-independent object is transmitted.

In yet another embodiment, the server 14 includes a computer readable medium (or software) that comprises instructions for receiving instructions to query a source (for example, the financial source 32) querying the source, receiving quote objects from the source, converting the quote objects into a first version, converting the first version into a second version, returning source-independent objects based on the second version, determining a destination (for example, the wireless device12) of the second version, converting the source-independent objects into a third version based on the characteristics of the destination, and wirelessly transmitting the third version based on a size of the source-independent objects and on a minimum availability of wireless spectrum. A conversion to the third version may be performed because the wireless device 12 may only be able to receive data via HTTP or via datagrams. As such, data is sent to the wireless device in a version able to be received and properly displayed. In a situation where various types of data can be received, a most efficient version to transfer such data can be used. Such efficiency can be based on the previously discussed encoding and caching methods.

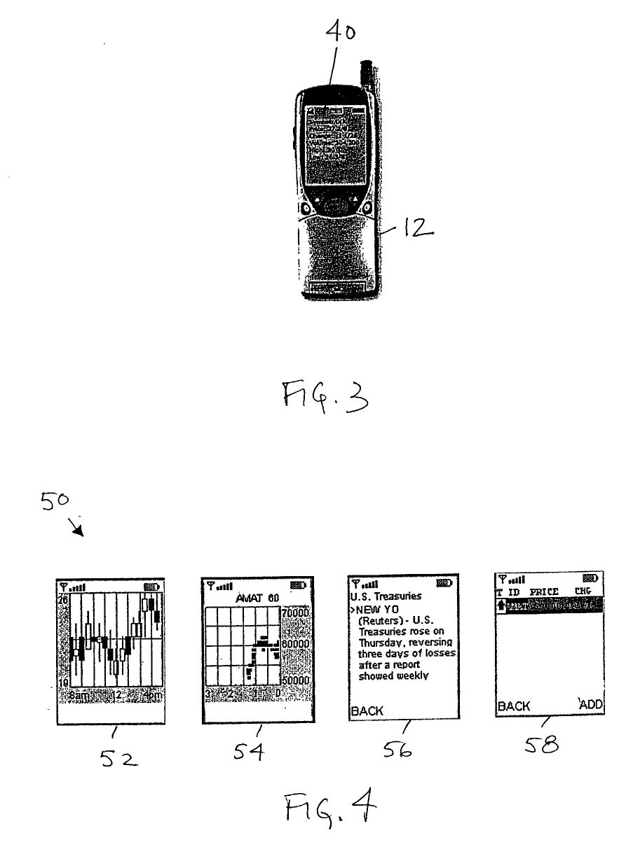

Referring now to FIGS. 3 and 4 a display area 40 of the wireless device 12 is depicted. A mobile phone is shown as the wireless device 12 by example only. Utilizing the aforementioned systems and methods, a plurality of financial information 50 may be securely displayed (in, for example, a graphical user interface format) on the display area 40 in real-time (or in near-real time). Such financial information 50 includes a charting display 52 which charts the financial data on an x and y coordinate plane with dots, lines, and/or financial candlesticks), a graphical list display 54 (able to support graphics such as arrows), a text list display 56 (that supports and word-wraps text according to a canvas width of the device 12), and a vertical scrolling display 58 (that provides an ability to view data north, south, east, and west of the display area 40).

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A method for transferring information, the method comprising:
wirelessly sending, by a client, a first request for information;
receiving, by a first server, the wirelessly sent first request;
converting, by the first server, the wirelessly sent first request into a second request for the information;
sending, by the first server, the second request;
receiving, by a second server, the second request;
sending, by the second server, the requested information;
receiving, by the first server, the requested information;
converting, by the first server, the requested information into a first format; and
sending, by the first server, the first format to the client.

2. The method of claim 1 further comprising wirelessly receiving, by the client, the first format.

3. The method of claim 2 further comprising converting, by the client, the first format into a second format.

4. The method of claim 3 further comprising displaying, by the client, the second format.

5. A method for transferring information, the method comprising:
initiating a program on a client;
requesting data via the program;
receiving, by a first module, the request, wherein the request includes instructions to access the data;
requesting the data based on the instructions;
receiving the data, from a second module;
translating the received data, by the first module, into a format adapted to be read and used by the client;
compressing the translated data;
converting the compressed data into a wirelessly transmittable format; and
wirelessly transmitting, by the first module, the converted data to the client.

6. A method for transferring financial information, the method comprising:
executing an application;
requesting remote data via the application;
sending the request by directing a data packet to an address of a server, wherein the data packet contains instructions to query a feed interface from a financial source to return a quote object;
returning the quote object to the server;
converting the quote object into a data structure;
returning a feed-independent object; and
wirelessly and intermittently transmitting the feed-independent object.

7. A system for transferring financial information, the system comprising:
at least one wireless device; and
at least one server;
wherein the wireless device:
requests remote data; and
sends the request by directing a data packet to an address of the server;
wherein the data packet contains instructions to query a feed interface from a financial source to return a quote object to the server; and
wherein the server:
converts the quote object into a data structure;
returns a feed-independent object; and
wirelessly and intermittently transmits the feed-independent object to the wireless device;
wherein the wireless device:
converts the feed-independent object into at least one of a following form: a chart, a graphical list, a text list, and a vertical scrolling capability; and
displays the at least one form;
wherein the converted form is based on display characteristics of the wireless device.

8. The system of claim 7, wherein the server returns a plurality of feed-independent objects from a plurality of quote objects.

9. The system of claim 8, wherein the server:
aggregates a portion of the plurality of feed-independent objects based on a type of the quote objects and on an order of the quote objects arrival;
records a number of common occurrences of the type; and
wirelessly and intermittently transmits:
the type;
the number of occurrences; and
the plurality of feed-independent objects that are not aggregated.

10. The system of claim 8, wherein the server:
monitors a type of the feed-independent objects;
records changes of the type; and
wirelessly and intermittently transmits the changes.

11. The system of claim 7, wherein the requested remote data by the wireless device comprises at least one of a following data from a group consisting of:
a connect request;
a full text news story;
a news bulletin;
a financial instrument chart;
a financial instrument quote;
a ping response;
add area of interest;
remove area of interest; and
a disconnect request.

12. The system of claim 9, wherein the quote object comprises at least one of the types from a group consisting of:
a financial instrument symbol;
a latest up tick indicator;
a latest down tick indicator;
a traded volume;
a previous days closing price;
a last traded price;
a change between the previous days closing price and the last traded price;
a high price;
a low price;
an open price;
a close price;
a bid price;
an ask price;
an exchange;
an electronic communication network;
a time of a trade; and
a size of the trade.

13. A wireless device adapted to transfer financial information, the wireless device comprising:
hardware; and
software;
wherein the hardware and the software are adapted to:
execute an application;
send a request for remote data, via the application, by directing a data packet to an address of a location of the remote data;
wirelessly receive a first converted version of the remote data;
convert the first converted version to a second converted version based on display characteristics of the wireless device; and
display the second converted version.

14. The wireless device of claim 13, wherein the second converted version comprises at least one of a following version: a chart, a graphical list, a text list, and a vertical scrolling capability.

15. The wireless device of claim 13, wherein the second converted version comprises a multimedia version comprising a live news feed, a financial instrument trading function, and related hypertext links.

16. A server adapted to transfer financial information, the server comprising:
hardware; and
software;
wherein the hardware and the software are adapted to:
receive instructions to query a feed interface from a financial source;
query the financial source;
receive quote objects;
convert the quote objects into data structures;
return feed-independent objects; and
perform at least one of a first actions and a second actions;
wherein the first actions comprise:
aggregating a portion of the feed-independent objects based on a type of the quote objects and on an order of the quote objects arrival;
recording a number of common occurrences of the type; and
wirelessly transmitting:
the type;
the number of occurrences; and
the feed-independent objects that are not aggregated;
wherein the second actions comprise:
monitoring a type of the feed-independent objects;
recording changes of the type; and
wirelessly transmitting the changes.

17. A computer readable medium comprising instructions for:
executing an application;
sending a request for remote data, via the application, by directing a data packet to an address of a location of the remote data;
wirelessly receiving a twice converted version of the remote data;
converting the twice converted version to a third converted version based on display characteristics of the wireless device; and
displaying the third converted version.

18. A computer readable medium comprising instructions for:
receiving instructions to query a source;
querying the source;
receiving quote objects from the source;
converting the quote objects into a first version;
converting the first version into a second version;
returning source-independent objects;
storing the source-independent objects; and
wirelessly transmitting, via a network to a destination, the stored source-independent objects based on a size of the source-independent objects and on a minimum availability of a wireless spectrum of the network.

19. The computer readable medium of claim 18 further comprising instructions for:
determining a destination of the stored wirelessly transmitted source-independent objects;
configuring the stored source-independent objects based on characteristics of the destination; and
wirelessly transmitting the stored configured source-independent objects to the destination.

20. The computer readable medium of claim 18 further comprising instructions for:
embedding a time stamp in the stored wirelessly transmitted objects;
measuring, by the time stamp, a latency of the network, wherein the latency comprises a difference between a time of transmitting the stored objects and a time of receiving the stored objects at the destination;
receiving the latency; and
determining an interval at which the stored objects are transmitted, wherein the interval is based on the latency.

21. The computer readable medium of claim 20 further comprising instructions for:
receiving a plurality of latencies;
determining an average latency based on the received plurality of latencies; and
if the average latency is above a threshold, not transmitting the stored objects to the destination.

22. The computer readable medium of claim 21 further comprising instructions for transmitting a latest returned source-independent object if the average latency is above the threshold.

23. A computer readable medium comprising instructions for:
receiving instructions to query a source;
querying the source;
receiving quote objects from the source;
converting the quote objects into a first version;
converting the first version into a second version;
returning source-independent objects based on the second version;
determining a destination of the second version;
converting the source-independent objects into a third version based on the destination; and
wirelessly transmitting the third version based on a size of the source-independent objects and on a minimum availability of wireless spectrum.
